(19) United States
(12) Patent Application Publication
(10) Pub. No.: US 2021/0221052 A1
(43) Pub. Date: Jul. 22, 2021

(54) LABEL DESIGN FOR ADDITIVE MANUFACTURING PROCESSES

(71) Applicant: MATERIALISE N.V., Leuven (BE)

(72) Inventor: Jeroen BERGER, Leuven (BE)

(21) Appl. No.: 17/225,999

(22) Filed: Apr. 8, 2021

Related U.S. Application Data
(63) Continuation of application No. PCT/US2019/055973, filed on Oct. 11, 2019.
(60) Provisional application No. 62/744,548, filed on Oct. 11, 2018.

(51) Int. Cl. B29C 64/153; B29C 64/118; G06T 7/70; G06T 19/20

(52) U.S. Cl. CPC B29C 64/153; B29C 64/118; B33Y 10/00; G06T 19/20; G06T 7/70

(57) ABSTRACT

The present disclosure relates to design and manufacture of 3D identification labels manufactured by agent-assisted fusion (AAF) techniques. Methods disclosed herein optimize the contrast between raised or engraved surfaces on a 3D identification label and minimize the effects of the dark-colored fusing agents used in AAF. Methods are disclosed for designing labels based on a configuration of light source and label detector.

### CROSS-REFERENCE TO RELATED APPLICATIONS

This application is a continuation of International Patent Application No. PCT/US2019/055973, filed on Oct. 11, 2019, which claims priority to U.S. Provisional Patent Application No. 62/744,548, filed on Oct. 11, 2018. The contents of each of these applications are hereby incorporated by reference in their entirety.

### BACKGROUND OF THE INVENTION

### Field of the Invention

The present disclosure relates to identification labels, such as 3D identification labels. The present disclosure relates to 3D identification labels produced by additive manufacturing, for example, by powder-bed fusion methods.

### Description of the Related Technology

In powder-bed fusion (PBF) methods of additive manufacturing, parts are manufactured in a layerwise manner by exposing successive layers of loose powder to targeted energy and/or chemicals. Within each layer, powder is fused into a desired cross-sectional shape, and cross-sections are fused together, eventually forming a whole part. Examples of PBF methods are laser sintering, selective laser melting, binder jetting, and agent-assisted fusion processes such as multi-jet fusion (MJF) or high-speed sintering. PBF methods are versatile, as both the powder and the processes used to fuse the powder may be optimized to result in parts with desired physical properties. By combining this versatility with the design freedom and the ease with which customer parts and/or complex designs may be built using any additive manufacturing technique, PBF methods are attractive for a growing number of manufacturing applications, where either prototypes or end-use parts are produced.

Tracking and sorting of parts remains a challenge when a large number of parts are produced by any method, including additive manufacturing or PBF methods. In mass customization, for example, copies of parts that are similar but not identical may be produced in a single build, and the parts must be sorted. In some manufacturing methods, parts can be distinguished on the basis of the time they are produced or the spatial location from which the part is recovered after production. In PBF methods, however, multiple parts may be produced simultaneously, after which the parts are recovered from a block of powder, and the spatial locations of the parts may not be preserved. One approach for labeling in PBF methods is to manufacture an identification label during the production process for each part, so that the part or tag that is coupled to the part has a unique identification label. Patent application PCT/US2018/04140, the contents of which are hereby incorporated in its entirety, discloses methods for selecting an area of the part or tag where the label will be printed, and preparing a 3D identification label that is easily read, with few or no steps required to make the label readable. A 3D identification label may be configured to include information about at least one of a part, an end-user of the part, a manufacturing process, a post-finishing process, or any other relevant information. The 3D identification label may be configured to be read easily by a data code reader.

Accordingly, it is important for a 3D identification label to have sufficient contrast between letters or codes so that a data reader can detect and process the identifying information in the label. While contrast can be enhanced by painting portions of the label or other post-processing methods, this requires extra time and effort. It is preferable to avoid these post-processing steps by producing a readable 3D identification label, and/or by adjusting lighting conditions (e.g., back-lighting or side-lighting) to increase contrast.

The problem of generating sufficient contrast in 3D identification labels may be more complex in certain PBF methods. In agent-assisted fusion (AAF) processes, for example, agents for fusing or detailing are selectively applied to the surface of the powder bed, and an infrared energy source is applied. The powder will absorb the infrared energy in a manner that is dependent on the agents, for example, fusing in the locations where fusing agents have been applied. The fusing agents used in AAF systems are often colored black, because dark colors absorb the infrared energy more efficiently than lighter colors. This results in parts with a gray color, which may range from lighter to darker shades. 3D identification labels made by AAF are also gray in color, and the contrast between regions on the 3D identification label may be insufficient for a data reader to process. Even under special lighting conditions, such as back-lighting or side-lighting, which normally help to increase contrast in a 3D identification label, the gray labels made by AAF cannot be detected by standard data readers. Thus far, these limitations have restricted labels for parts made by AAF to simple text labels that are human readable and/or to labels which are applied on or attached to the parts after printing. There remains a need in the art for methods to improve labeling of parts made by AAF, for example, manufacturing 3D identification labels by AAF that are suitable for simple and/or automated reading.

### SUMMARY OF THE INVENTION

Certain aspects of the present disclosure relate to design and manufacture of 3D identification labels manufactured by additive manufacturing processes. The methods optimize the contrast between raised and engraved surfaces on a 3D identification label, which may enable improved detection of information as represented by codes, pattern, and/or shapes in the label. Exemplary methods disclosed herein may minimize the effects of the dark-colored fusing agents used in additive manufacturing processes such as agent-assisted fusion (AAF) processes. In addition, methods are disclosed for designing labels based on a configuration of light source and label detector.

A first aspect of the present invention relates to a method for manufacturing a 3D identification label on an agent-assisted fusion (AAF) device, the method comprising: receiving a digital representation of the 3D identification label; generating instructions for manufacturing the 3D identification label, wherein the instructions when executed by the AAF device, cause the AAF device to orient the digital representation of the 3D identification label at an angle greater than 1° relative to a surface of a build plate of the AAF device; and manufacturing the 3D identification label on the AAF device according to the instructions. The AAF device may be a multi-jet fusion device.

In some embodiments, the 3D identification label is located on an object. At least one portion of the object may be oriented at an angle parallel to the surface of the build plate.

The 3D identification label may comprises a reference surface including a first side and a second side located on opposite sides of the reference surface, and a first raised surface formed above the reference surface on the first side. The 3D identification label may further comprise a second raised surface formed above the reference surface on the second side. A distance from the first side of the reference surface to the second side of the reference surface may range from 0.3 mm-0.5 mm.

The 3D identification label may comprise a reference surface and an engraved surface that is recessed into the reference surface. The 3D identification label may comprise one or more geometric shapes.

When the digital representation of the 3D identification label is oriented at an angle greater than 1° relative to a surface of a build plate of the AAF device, the angle may be in a range between 1° and 90°, for example, in a range between 15° and 45°.

A build plate may be positioned parallel to a powder surface of powder in the AAF device.

In AAF methods, the AAF device may use a dark colored (e.g., black or gray) agent. Accordingly, manufacturing the 3D identification label may comprise manufacturing the 3D identification label on the AAF device using an agent that is dark colored. The agent may be a binding agent.

In some embodiments, the 3D identification label is located on an object, and wherein generating the instructions may comprises determining an orientation of the object relative to the surface of the build plate; determining a first orientation of the 3D identification label with respect to the orientation of the object such that a second orientation of the 3D identification label with respect to the surface of the build plate is at the angle greater than 1°; and positioning the 3D identification label on the object based on the first orientation.

A further aspect of the present disclosure relates to manufacturing a 3D identification label configured for reading under a light source. The light source may be located to the side of the 3D identification label, and contrast may be generated by the position of the lighting. An exemplary method for manufacturing a 3D identification label configured for reading under a light source may comprise determining an angle α for the light source and an angle θ for a detector used to read the 3D identification label, wherein α and θ are measured relative to a reference surface on the 3D identification label; calculating a pixel height to pixel width ratio for at least one geometric structure in the 3D identification label based on the angles α and θ; and manufacturing the 3D identification label, wherein the at least one geometric structure is designed to conform to the determined pixel height to pixel width ratio.

In some embodiments, the pixel height to pixel width ratio may be in a range of 1-10, for example, the pixel height to pixel width ratio is 4 or 5. The angles α and θ may range from 7° to 55°. For example, a light source may be positioned to illuminate the 3D identification label from a side.

### BRIEF DESCRIPTION OF THE DRAWINGS

FIG. 1 illustrates an example of a computer environment suitable for the implementation of 3D object design and manufacturing.

FIG. 2 illustrates a functional block diagram of one example of a computer.

FIG. 3 shows a high level process for manufacturing a 3D object using the methods and systems disclosed herein.

FIG. 4 is an example of a scanning system which may be used for the methods and systems disclosed herein.

FIGS. 5A-5B show exemplary lighting conditions that may be used to enhance contrast between portions of a 3D identification label.

FIGS. 6A-6D show the results of manufacturing a 3D identification label by AAF at 4 different orientations, as measured from the surface of the build plate.

FIG. 7 shows an exemplary side-lighting configuration for a 3D identification label in which contrast between raised and recessed portions may be created by shadows.

### DETAILED DESCRIPTION OF CERTAIN INVENTIVE EMBODIMENTS

Embodiments of this application relate to design and manufacture of 3D identification labels manufactured by agent-assisted fusion (AAF) techniques. Methods disclosed herein optimize the contrast between raised or engraved surfaces on a 3D identification label and minimize the effects of the dark-colored fusing agents used in AAF.

### Additive Manufacturing Systems

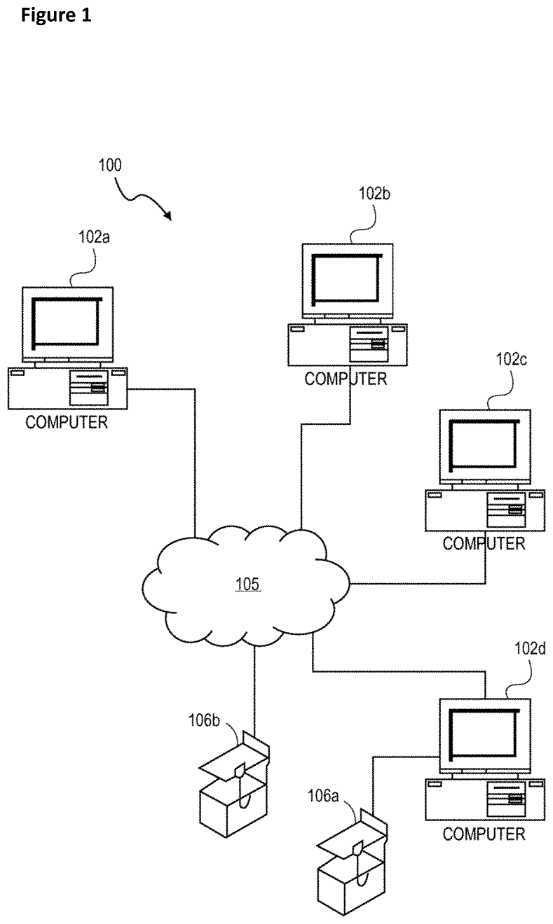

Embodiments of the invention may be practiced within a system for designing and manufacturing 3D objects. Turning to FIG. 1, an example of a computer environment suitable for the implementation of 3D object design and manufacturing is shown. The environment includes a system 100. The system 100 includes one or more computers 102a-102d, which can be, for example, any workstation, server, or other computing device capable of processing information. In some aspects, each of the computers 102a-102d can be connected, by any suitable communications technology (e.g., an internet protocol), to a network 105 (e.g., the Internet). Accordingly, the computers 102a-102d may transmit and receive information (e.g., software, digital representations of 3-D objects, commands or instructions to operate an additive manufacturing device, etc.) between each other via the network 105.

The system 100 further includes one or more additive manufacturing devices or apparatuses (e.g., 3-D printers) 106a-106b. As shown the additive manufacturing device 106a is directly connected to a computer 102d (and through computer 102d connected to computers 102a-102c via the network 105) and additive manufacturing device 106b is connected to the computers 102a-102d via the network 105. Accordingly, one of skill in the art will understand that an additive manufacturing device 106 may be directly connected to a computer 102, connected to a computer 102 via a network 105, and/or connected to a computer 102 via another computer 102 and the network 105.

It should be noted that though the system 100 is described with respect to a network and one or more computers, the techniques described herein also apply to a single computer 102, which may be directly connected to an additive manufacturing device 106.

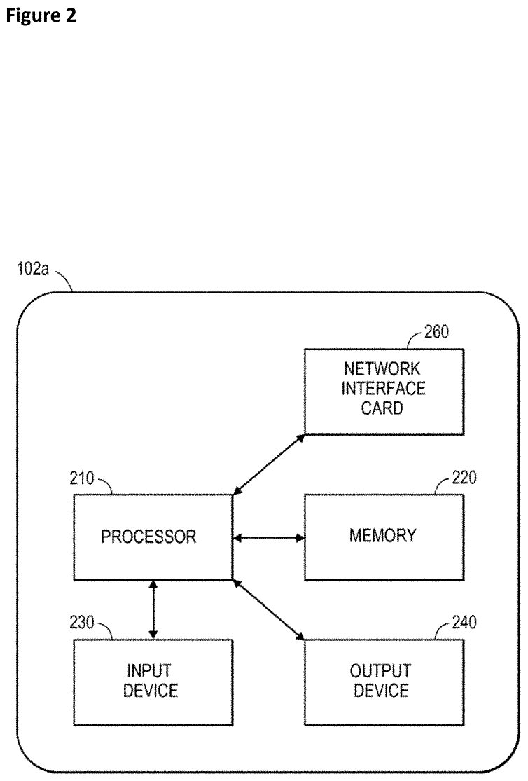

FIG. 2 illustrates a functional block diagram of one example of a computer of FIG. 1. The computer 102a includes a processor 210 in data communication with a memory 220, an input device 230, and an output device 240. In some embodiments, the processor is further in data communication with an optional network interface card 260. Although described separately, it is to be appreciated that functional blocks described with respect to the computer 102a need not be separate structural elements. For example, the processor 210 and memory 220 may be embodied in a single chip.

The processor 210 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 210 can be coupled, via one or more buses, to read information from or write information to memory 220. The processor may additionally, or in the alternative, contain memory, such as processor registers. The memory 220 can include processor cache, including a multi-level hierarchical cache in which different levels have different capacities and access speeds. The memory 220 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 210 also may be coupled to an input device 230 and an output device 240 for, respectively, receiving input from and providing output to a user of the computer 102a.

Suitable input devices include, but are not limited to, a keyboard, buttons, keys, switches, a pointing device, a mouse, a joystick, a remote control, an infrared detector, a bar code reader, a scanner, a video camera (possibly coupled with video processing software to, e.g., detect hand gestures or facial gestures), a motion detector, or a microphone (possibly coupled to audio processing software to, e.g., detect voice commands). Suitable output devices include, but are not limited to, visual output devices, including displays and printers, audio output devices, including speakers, headphones, earphones, and alarms, additive manufacturing devices, and haptic output devices.

The processor 210 further may be coupled to a network interface card 260. The network interface card 260 prepares data generated by the processor 210 for transmission via a network according to one or more data transmission protocols. The network interface card 260 also decodes data received via a network according to one or more data transmission protocols. The network interface card 260 can include a transmitter, receiver, or both. In other embodiments, the transmitter and receiver can be two separate components. The network interface card 260, can be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein.

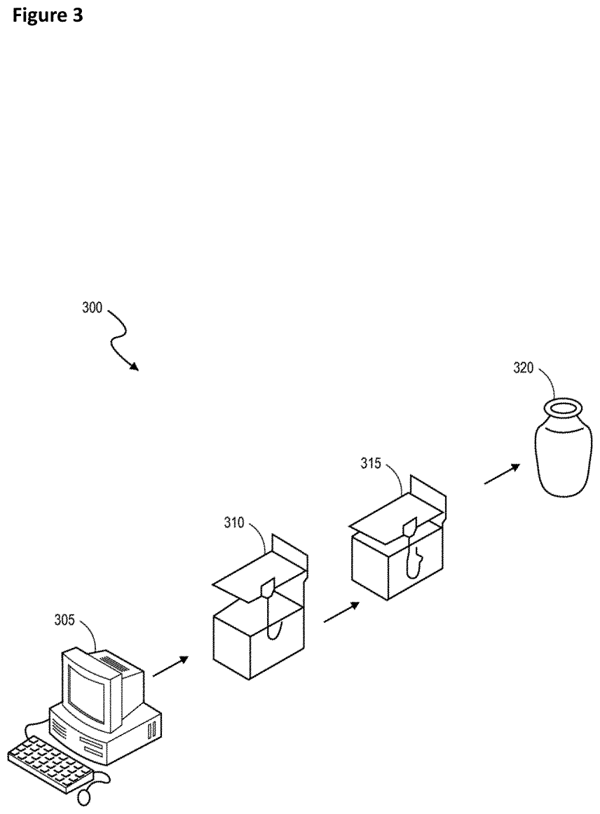

FIG. 3 illustrates a process 300 for manufacturing a 3-D object or device. As shown, at a step 305, a digital representation of the object is designed using a computer, such as the computer 102a. For example, 2-D or 3-D data may be input to the computer 102a for aiding in designing the digital representation of the 3-D object. Continuing at a step 310, information is sent from the computer 102a to an additive manufacturing device, such as additive manufacturing device 106, and the device 106 commences the manufacturing process in accordance with the received information. At a step 315, the additive manufacturing device 106 continues manufacturing the 3-D object using suitable materials, such as a liquid resin.

These suitable materials may include, but are not limited to a photopolymer resin, polyurethane, methyl methacrylate-acrylonitrile-butadiene-styrene copolymer, resorbable materials such as polymer-ceramic composites, etc. Examples of commercially available materials are: DSM Somos® series of materials 7100, 8100, 9100, 9420, 10100, 11100, 12110, 14120 and 15100 from DSM Somos; ABSplus-P430, ABSi, ABS-ESD7, ABS-M30, ABS-M30i, PC-ABS, PC ISO, PC, ULTEM 9085, PPSF and PPSU materials from Stratasys; Accura Plastic, DuraForm, CastForm, Laserform and VisiJet line of materials from 3-Systems; the PA line of materials, PrimeCast and PrimePart materials and Alumide and CarbonMide from EOS GmbH. The VisiJet line of materials from 3-Systems may include Visijet Flex, Visijet Tough, Visijet Clear, Visijet HiTemp, Visijet e-stone, Visijet Black, Visijet Jewel, Visijet FTI, etc. Examples of other materials may include Objet materials, such as Objet Fullcure, Objet Veroclear, Objet Digital Materials, Objet Duruswhite, Objet Tangoblack, Objet Tangoplus, Objet Tangoblackplus, etc. Another example of materials may include materials from the Renshape 5000 and 7800 series. For HP's multi-jet fusion processes, HP 3D High Reusability PA12, Vetostint 3D Z2773 PA12, HP 3D High Reusability PA12 Glass Beads, and HP 3D High Reusability PA11 are examples of materials. Further, at a step 320, the 3-D object is generated.

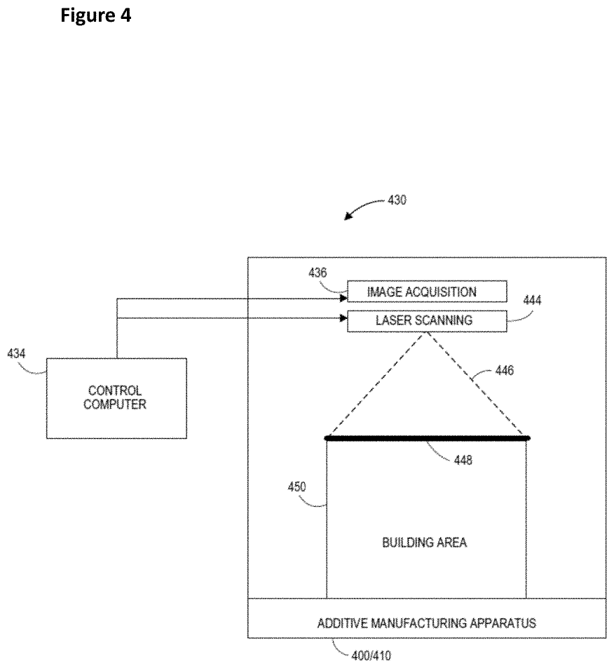

FIG. 4 illustrates an exemplary additive manufacturing apparatus 400 for generating a three-dimensional (3-D) object. In this example, the additive manufacturing apparatus 400 is a powder-bed fusion apparatus, e.g., laser sintering device. The laser sintering device 400 may be used to generate one or more 3D objects layer by layer. The laser sintering device 400, for example, may utilize a powder (e.g., metal, polymer, etc.), to build an object a layer at a time as part of a build process.

Successive powder layers are spread on top of each other using, for example, a recoating mechanism (e.g., a recoater blade, drum, or roller). The recoating mechanism deposits powder for one or more layers as it moves across the build area in one or more directions. After deposition of a layer, a computer-controlled CO₂ laser beam scans the surface and selectively binds together the powder particles of the corresponding cross section of the product. In some embodiments, the laser scanning device is an X-Y moveable infrared laser source. As such, the laser source can be moved along an X axis and along a Y axis in order to direct its beam to a specific location of the top most layer of powder. Alternatively, in some embodiments, the laser scanning device may comprise a laser scanner which receives a laser beam from a stationary laser source, and deflects it over moveable mirrors to direct the beam to a specified location in the working area of the device. During laser exposure, the powder temperature rises above the material (e.g., glass, polymer, metal) transition point after which adjacent particles flow together to create the 3D object. The device 400 may also optionally include a radiation heater (e.g., an infrared lamp) and/or atmosphere control device. The radiation heater may be used to preheat the powder between the recoating of a new powder layer and the scanning of that layer. In some embodiments, the radiation heater may be omitted. The atmosphere control device may be used throughout the process to avoid undesired scenarios such as, for example, powder oxidation.

The additive manufacturing apparatus may be a powder-bed fusion apparatus configured for an AAF process. Similar to laser sintering, the raw material for parts built by an AAF process is a powder that has been dispensed into a build chamber or powder bed. Layers of powder are deposited, spread with a recoating mechanism, and then parts are built in cross-sectional layers. However, unlike laser sintering, it is not the action of a laser scanner that fuses the cross-sectional layer, but rather, the combined action of a chemical agent such as a heat-absorbing fusion agent and an energy source. Instead of a laser scanner, the AAF apparatus comprises a mechanism configured for applying agents onto the powder bed, for example, through nozzles or jets, and lamps which are configured to pass over the powder surface after the agents have been jetted. Where fusing agents have been applied onto the powder, they capture and distribute heat or energy from the lamps and promote fusion of powder in those areas on the powder surface. In some embodiments, the lamps are infrared lamps. A detailing agent may also be applied around all or a portion of the areas where fusion agents have been applied, in order to refine the boundaries between powder that will be fused and powder that will not be fused. Inhibiting agents may also be applied to prevent or reduce fusion in specific areas of the powder surface. Other agents may be used to modulate the fusing process and/or obtain specific properties in the finished part. For example, colored agents or texturizing agents may be used to produce multi-colored parts or different surface textures. In addition, chemical agents may be selectively applied to change the mechanical properties in regions of the part, or to provide a specific finish such as a flame-resistance.

The control computer 434 may be configured to control operations of the additive manufacturing apparatus 400. In some embodiments, the control computer may be one or more computers 102 from FIG. 2 or the computer 305 from FIG. 3. In some embodiments, the control computer 434 may be a controller built into or configured to interface with the additive manufacturing apparatus 400.

Various embodiments disclosed herein provide for the use of a computer control system. A skilled artisan will readily appreciate that these embodiments may be implemented using numerous different types of computing devices, including both general purpose and/or special purpose computing system environments or configurations.

Examples of well-known computing systems, environments, and/or configurations that may be suitable for use in connection with the embodiments set forth above may include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, cloud computing and the like. These devices may include stored instructions, which, when executed by a microprocessor in the computing device, cause the computer device to perform specified actions to carry out the instructions. As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

Aspects and embodiments of the inventions disclosed herein may be implemented as a method, apparatus or article of manufacture using standard programming or engineering techniques to produce software, firmware, hardware, or any combination thereof. The term “article of manufacture” as used herein refers to code or logic implemented in hardware or non-transitory computer readable media such as optical storage devices, and volatile or non-volatile memory devices or transitory computer readable media such as signals, carrier waves, etc. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

The control computer 434 may be connected to a laser scanning device 444 or to an agent jetting system (e.g., an ink jetting system). The laser scanning device may include movable mirrors which can direct the laser beam received from a laser source into the building area. The laser source may also be a movable laser source, or it may also be the laser scanner provided in an additive manufacturing apparatus 400. The agent jetting system may jet a defined pattern of an agent (e.g., a heat-absorbing fusing agent) that corresponds to a cross-section of a part across the powder surface. The control computer 434 may further include software which controls the movement and functionality of the laser scanning system 444 or the agent jetting system and/or an energy source such as a heat lamp. As such, the control computer 434 may be configured to control the moment and activation of the laser scanning device or the agent system and energy source.

The control computer 434 may further be configured to interface with an image acquisition assembly 436, such as to receive data/images from the image acquisition assembly 436. The control computer 434 may further be configured to process the data/images to determine if errors have or will occur in the build process as described herein. The control computer 434 may further be configured to control when and how the image acquisition assembly 436 captures images.

The image acquisition assembly 436 may be configured to attach to, be integrated with, and/or sit separate from the additive manufacturing apparatus 400 and placed in such a position to monitor the building area 450 and/or the build surface. Further, the image acquisition assembly 436 may be configured to be stationary, or moveable (such as based on control signals received from the control computer 434) to monitor the building area 450 from different angles.

The image acquisition assembly 436 may be configured to acquire images of a calibration plate 448 or a build surface. More particularly, the image acquisition assembly 436 may be configured to acquire images of laser spots and/or other markings made on the calibration plate 448 or build surface by the scanning system 444.

The image acquisition assembly 436 may include a camera, for example, an optical camera. The camera may be a commercial off-the-shelf (“COTS”) digital camera having sufficient resolution to capture spots and other markings on the calibration plate 448 or build surface in sufficient detail to calibrate the scanning device. In some embodiments, the image acquisition assembly is selected from an optical camera, a thermal imaging device, an IR camera, or a sensor that transfers other signals to visual signals.

A camera may take the form of a special purpose camera which is configured to capture spots reflecting from the surface of the calibration plate. In order to capture spots on the calibration plate, it may be necessary to position the camera so that it points to the area near the spot created by a scanner in the scanning system 444. Accordingly, the image acquisition assembly 436 may also include a mount. In some embodiments, the mount may be a tilt-pan mount, which provides a range of motion sufficient to capture images in various locations on the calibration plate 448. The mount may be driven by a motor. The motor may be configured to receive control signals from the control computer 434 which provide instructions for the movement of the camera 450. In some embodiments, in addition to having a tilt-pan range of motion, the camera 450 may be further mounted on a projecting arm of a crane, commonly referred to as a jib. The jib may provide a further range of motion by allowing the camera not only to tilt and pan, but also to physically move its location in order to better acquire images of spots and/or markings on the calibration plate 448 or build surface.

### 3D Identification Labels

The following description and the accompanying figures are directed to certain specific embodiments. The embodiments described in any particular context are not intended to limit this disclosure to the specified embodiment or to any particular usage. Those of skill in the art will recognize that the disclosed embodiments, aspects, and/or features are not limited to any particular embodiments. For example, reference to “a” layer, component, part, etc., may, in certain aspects, refer to “one or more.”

Described herein are designs for 3D identification labels (e.g., 3D barcodes). In certain aspects, the 3D identification label includes a raised surface, comprising one or more geometric shapes or patterns (e.g., dots, rectangles, blocks, hexagons, parallel lines, etc.), that is formed on a reference surface (e.g., a flat surface, curved surface, uneven surface, etc.). Certain aspects are described with respect to a flat surface as a reference surface with a raised surface that is formed above the reference surface. However, one of skill in the art should understand that the reference surface may not necessarily be a flat surface and may be another surface type (e.g., uneven, curved, etc.) on which a raised surface is formed. The design of the raised surface including geometric shapes or patterns representing data. In certain aspects, the 3D identification label includes raised surfaces on two opposite sides of the reference surface. The raised surface on each side of the reference surface are aligned with each other, such that they form a contiguous geometric shape or pattern from one side of the reference surface to another side of the reference surface (e.g., with the reference surface intersecting the contiguous geometric shape). Since the raised surface is formed on the reference surface, the geometric shape or pattern forming the 3D identification label is thicker than the reference surface it is formed on. Accordingly, based on the material (e.g., density of material) and/or color of material used for the reference surface and raised surface, the contrast between the raised surface and the reference surface on each side of the reference surface is enhanced, thereby making reading the 3D identification label easier using a scanning device (e.g., a barcode scanner, a camera, a photosensor, an X-ray machine, etc.). Further, where the raised surface is on both sides of a reference surface, the 3D identification label can be read from either side of the reference surface, and the contrast between the raised surface and reference surface may further be enhanced due to the additional thickness of the contiguous geometric shape or pattern including both raised surfaces. In certain aspects, the reference surface is not included, and instead the raised surfaces are coupled together at only a few points (e.g., around the edges of the raised surfaces) and instead of the reference surface there is an empty space.

In certain aspects, the 3D identification label comprises one or more geometric shapes or patterns (e.g., dots, rectangles, blocks, hexagons, parallel lines, etc.) of different heights. For example, different portions of the 3D identification label may have different heights, which may be distinguishable by a scanning device (e.g., portions of greater height may be made of more material and have a darker shade or contrast). The different heights may correspond to different data represented by the 3D identification label. In some such aspects, raised surfaces on opposite sides of the reference surface may be asymmetrical and represent the same or different data.

In certain aspects, the 3D identification label comprises one or more geometric shapes or patterns (e.g., dots, rectangles, blocks, hexagons, parallel lines, etc.) having different contrast coatings. For example, different portions of the 3D identification label may have different coatings thereon that change the shade or contrast of each portion, which may be distinguishable by a scanning device. The different contrast coatings may correspond to different data represented by the 3D identification label. For example, though in certain aspects, different materials are discussed as being used for different portions of a 3D identification label, additionally or alternatively, different contrast coatings may be used for such portions.

In certain aspects, the 3D identification label comprises one or more geometric shapes or patterns (e.g., dots, rectangles, blocks, hexagons, parallel lines, etc.) of different densities. In certain aspects, the geometric shapes or patterns of different densities include raised surfaces as described. In certain aspects, the geometric shapes or patterns of different densities include material that is under the outer surface (e.g., reference surface) of an object (e.g., and may not be “visible” (e.g., to the naked eye). For example, the material in the object at a location of the 3D identification label may be generated with different densities representing the 3D identification label. In certain aspects, an X-ray device, ultrasound, or other appropriate scanning device may be used to measure the different densities to read the 3D identification label. Differences in parts of the 3D identification label may also be detected using a thermal imaging device or infrared device. In certain aspects, a difference in densities may result from a sintered/molten 3D identification label comprising a raised or engraved surface, as contrasted with unsintered/unmolten powder surrounding the 3D identification label.

In certain aspects, instead of raised surfaces above a reference surface, the 3D identification label comprises one or more lowered surfaces that recess into the reference surface, similar to the raised surfaces, but inverted. In certain aspects, similar to the raised surfaces, the lowered surfaces may be on each side of reference surfaces and aligned with each other, such that they form a contiguous geometric shape or pattern from one side of one reference surface to another side of the other reference surface.

In certain aspects, a 3D identification label (whether on a raised surface or on an engraved surface) may appear darker in shading than the reference surface, due to a difference in color, contrast, density, material, or other factors as described herein. Alternatively, a 3D identification label may appear lighter in shading than the reference surface. A label reader may be configured to detect the difference, for example, a difference between dark and light structures on the label. Using an example of a 3D identification label that is a barcode, the barcode may first be generated in 2D so that information is encoded in a pattern of first shapes and contrasting second shapes. In some embodiments, the first shapes appear dark (e.g., black) and the second shapes appear light (e.g., white) in the 2D barcode. From the 2D barcode, a 3D barcode may be generated in which 3D structures corresponding to the first shapes from the 2D barcode are raised in a plane above the second shapes from the 2D barcode. The raised 3D structures may appear dark while the second shapes in a lower plane appear light. Alternatively, the configuration may be reversed, so that the first shapes in the raised 3D structures appear light while the second shapes in the lower plane appear dark.

In certain embodiments, the 3D barcode may be generated so that 3D structures corresponding to the first shapes from the 2D barcode are engraved or recessed in a plane below the second shapes from the 2D barcode. The recessed structures corresponding to the first shapes may appear dark, while the second shapes appear light, or alternatively, the recessed structures corresponding to the first shapes may appear light, while the second shapes appear dark. While a first portion of the label may be maintained as dark while the second portion of the label may be maintained as light, it may also be possible to reverse this relationship so that the first portion of the label appears light and the second portion appears dark. In either case, the relationship between light and dark portions in raised structures or in recessed structures may be maintained regardless of whether the first portion is raised or recessed, and appears dark or light.

In certain aspects, lighting conditions may modulate the appearance of light or dark patterns of the 3D identification label (e.g., black and white shapes that encode information in a barcode) and the contrast between them. Under backlighting conditions, a light source may be held on one side of the 3D identification label, and information from the label may be viewed from the opposite side after light passes through. With backlighting, contrast between light and dark may be detected when light passes more extensively through a first portion of the label than through a second portion of the label. The first portion of the label may then appear light, while the second portion appears dark. In general, the first portion may correspond to a first plane, while the second portion projects from the first plane. The second portion may project from the first plane on a same side as the backlight and in a direction towards the light source, or the second portion may project from the first plane on the opposite side of the light source, e.g., on the opposite side of the backlight. The thickness of the first plane may be configured to allow light to pass, and may be determined for specific geometries on the 3D identification label and/or for specific combinations of fusing agents and powder, which may vary in translucency. In some embodiments, the thickness may be at least 0.1, 0.2, or 0.3 mm. Under side lighting conditions, in which a light source is angled onto the 3D identification label from an angle above at least one surface on the 3D identification label, shadows may be created in recessed portions of the label, so that they appear black.

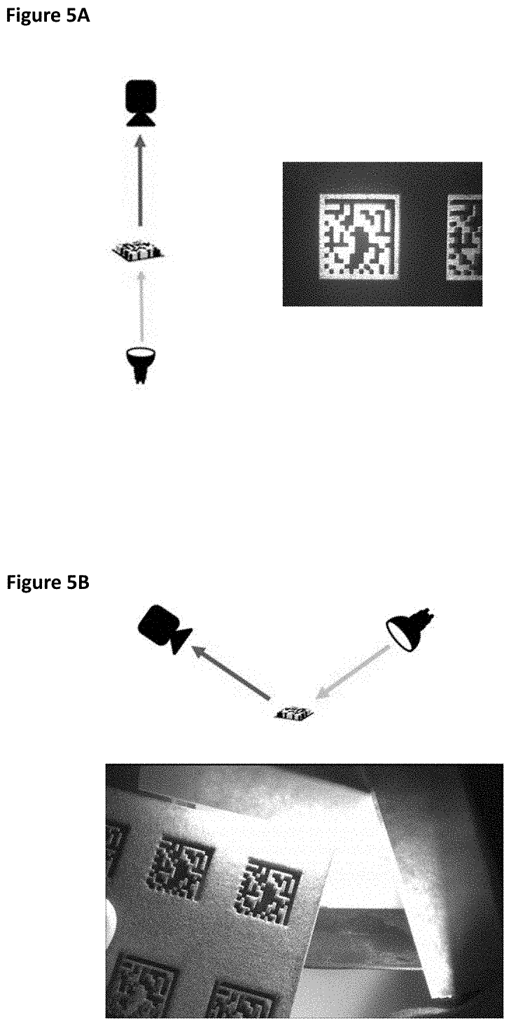

In certain aspects, a 3D identification label may comprise a border, so that the outline of the label is contrasted with the surrounding plane. For example, a border in FIG. 5A is visible around the label. Without such a border, the portions of the label at the outermost edge may be indistinguishable from the background.

In certain aspects, a 3D identification label may comprise a surface texture that comprises information, such as a unique texture that corresponds to information about an object or may be linked to a specific object. Surface textures may comprise patterns and/or pictures. In certain aspects, a surface texture may comprise Braille. Surface textures may be imaged, or may be measured by any means for determining and/or mapping surface roughness.

In certain aspects, the 3D identification label comprises two or more colors. The colors may be applied to the object during or after manufacturing, for example by painting or dyeing the object. Colors may be manufactured as part of the object, for example, by using differently colored build materials, or materials that differ in composition. Colors may be manufactured in AAF using differently colored fusing agents. Shades of colors may be applied to the object, or may be visible under certain lighting conditions, such as blacklight.

In certain aspects, the 3D identification label may comprise more than one material. The 3D identification label may comprise two or more types of plastic or two or more types of metal, or a combination of plastic and metal. In certain aspects, the 3D identification label may be an RFID tag that is manufactured from a combination of metal and plastic, for example, by using a build material comprising plastic and metal. After manufacturing, parts of the metal or plastic may be removed or refined by post-finishing. In certain aspects, the 3D identification label comprises carbon fibers, or a material impregnated with carbon fibers.

In some embodiments, information in a 3D identification label may be represented as a data matrix, 3D QR code, Aztec, bar code (e.g. 2D or 3D bar code), textured label, color or shadow-based label, combination of label types, or combination with text, and more. 3D identification labels may be machine readable 3D identification labels, for example, labels which comprise machine-readable data. Machine-readable data may be readily processed by computers, such as human-readable data that is marked up for reading by machines or data file formats intended for processing by machines. Machine readable 3D identification labels may be configured for automated reading by label readers.

Further described herein are systems and methods for manufacturing an object including a 3D identification label, and systems and methods for reading a 3D identification label. In certain aspects, the 3D identification label is manufactured as part of an object using an additive manufacturing AM process. A 3D identification label may be manufactured separately from the object and attached during or after manufacturing. In certain aspects, the 3D identification label is manufactured near an object or on structures associated with the object. For example, the 3D identification label may be manufactured as part of a box around one or more objects, and the label may contain information about the one or more objects. In additive manufacturing processes such as powder bed fusion processes, this type of box may be manufactured around the one or more objects so that the box may be lifted out of the powder bed and the one or more objects will be contained in the box. The 3D identification label may be manufactured on a support structure that provides physical support and/or a means for heat dissipation to an object during the additive manufacturing process. In certain aspects, the 3D identification label may be a break-off tag that connects to the object, box, or support through a bridge. The bridge may be configured to break easily, for example, if the bridge is a thin structure like a single column or a lattice structure comprising beams. The break-off tag may be connected to one location on an object, box, or support, or may be connected at multiple locations, for example, through multiple bridges.

### Label Design and Manufacture for Agent-Assisted Fusion Processes

In agent-assisted fusion (AAF) processes, agents for fusing or detailing are selectively applied to the surface of a powder bed, and an infrared energy source is applied. The powder absorbs the infrared energy in a manner that is dependent on the agents, for example, fusing in the locations where fusing agents have been applied. The fusing agents used in AAF systems are often colored black, because dark colors absorb the infrared energy more efficiently than lighter colors.

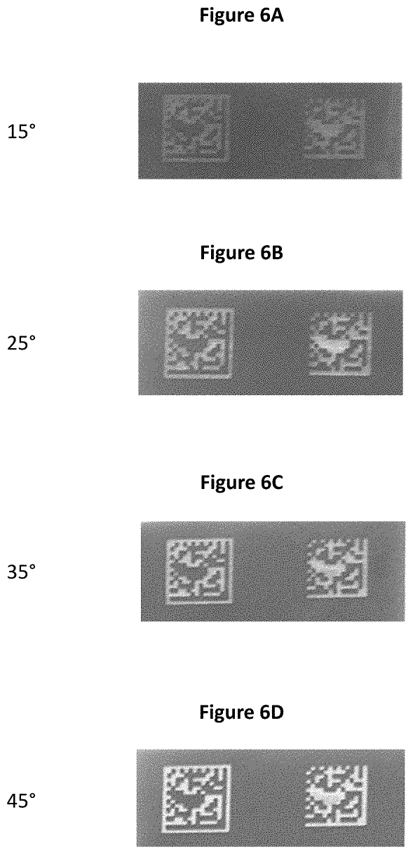

Because of the dark colored agents used in AAF processes, the contrast between portions of 3D identification labels may be reduced. Even under lighting conditions that enhance contrast between raised and lowered portions of 3D identification labels, the labels produced by AAF processes may lack sufficient contrast for detection. A back-light may enhance contrast between thicker or thinner regions of a 3D identification label, such as a raised (or engraved) surface and a reference surface, because more light is transmitted through the thinner regions and less light is transmitted through the thicker regions. FIG. 5A shows an exemplary back-light set-up and a view of a 3D identification label in which the contrast between raised surfaces on the label and a reference surface are enhanced. A side-light may enhance contrast when shadows are generated along raised surfaces or engraved (recessed) surfaces on the 3D identification labels. FIG. 5B shows an exemplary side-light set-up and a view of a 3D identification label in which contrast between raised surfaces on the label and a reference surface are enhanced. For AAF labels, however, the high concentrations of dark colored agents limits the transmission of back-lighting through reference surfaces of the label and/or minimizes the shadows that are normally formed under a side-light. For example, the dark colored agents accumulate in the z-direction as the layers are built upon each other, so that differences in color and translucency between a dark colored reference surface and a dark-colored raised or engraved surface are not sufficient. In particular, when AAF labels are printed at flat orientation (e.g., the label, such as its reference surface, is oriented at an angle of 0° relative to the surface of the build plate while being printed), dark colored agents may accumulate. Described herein are methods for modulating the concentration of dark colored agents that are present in the AAF labels. In certain aspects, labels may be printed at an angle that is not 0°, for example, at an angle of 10° or higher, as compared to the surface of the build plate. For example, the reference surface, top surface, flat surface, or etc. of the AAF label may be oriented at an angle that is not 0° relative to the surface of the build plate while being printed. In some embodiments, the labels may be printed at an angle of 1°, 5°, 10°, 15°, 20°, 25°, 30°, 35°, 40°, 45°, 50°, 55°, 60°, 65°, 70°, 75°, 80°, 85°, 90°, or any angle in between these values, as measured relative to the surface of the build plate. The labels may be configured with sufficient dark color that a surface of the geometric shapes in the label (whether raised or engraved) contrast a reference surface, while the reference surface is configured to be partially-translucent, for example, under back-lighting. FIG. 6 illustrates the difference in contrast when labels are printed at different orientations. In each of FIGS. 6A-6D, the same label has been printed in 4 different orientations, either as a raised label (left) or an engraved label (right), and backlit. All labels are printed from the same material with the same wall thicknesses and proportions. FIG. 6A show the label printed at an angle of 15° from the surface of the build platform, FIG. 6B shows the label printed at an angle of 25°, FIG. 6C shows the label printed at an angle of 35°, and FIG. 6D shows the label printed at an angle of 45°. The contrast between the raised or engraved surface and the reference surface is clearest when the label is printed at an angle of 45°.

In some aspects, AAF labels with a raised surface may be printed at an orientation that is not 0°, and wall thicknesses of any geometric shapes of the raised portions of the label may be configured to minimize the deposition of dark colored agents in each layer. Exemplary wall thicknesses for the geometric shapes may range from 0.3 mm-0.5 mm. A minimum thickness may be based on AAF building capabilities and part durability during post-processing, while a maximum thickness may be based on translucency limits due to ink deposition.

Wall thickness may refer to the thickness between a first side and a second side of a reference surface. In the case of an engraved 3D identification label, the thickness between the first side and the second side of the reference surface may be reduced by the depth of the engraving (e.g., by the height of the engraving or by the extent to which the 3D identification label is recessed into the reference surface). In some embodiments, the wall thickness may range from 0.1 mm-1.00, for example, 0.3 mm-0.5 mm. In the case of a raised 3D identification label, the wall thickness may correspond to the portion of the label that is not raised above the first (and/or second) side of the reference surface, and may range from 0.1 mm-1.00, for example, 0.3 mm-0.5 mm.

Because wall thicknesses of the raised portions of the label may be fragile because of their small dimensions. In certain aspects, the raised portions are configured to accumulate more dark-colored agents than the reference surface. Accordingly, even if a piece of the raised portion breaks, the entire geometric shape retains enough dark color that a contrast between the raised portion and the reference surface may still be observed.

In certain aspects, AAF labels with either a raised surface or an engraved surface may be designed with consideration of the size of the label and the height of the raised surface or engraved surface, as measured from the reference surface.

A further aspect of the present disclosure relates to a method for manufacturing a 3D identification label configured for reading when illuminated by a light source from the side of the 3D identification label. This method may be used for manufacturing AAF labels and/or for manufacturing any 3D identification label using any type of additive manufacturing process. The methods may be used to increase contrast between parts of the 3D identification label, thereby enhancing detectability (e.g., readability) of the label.

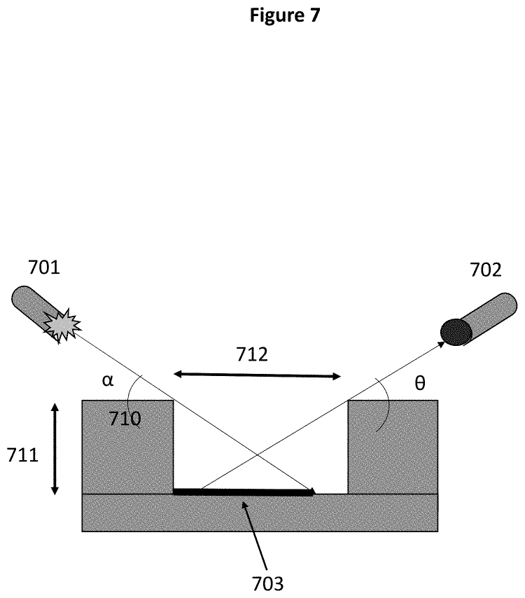

In some embodiments, for example, under a side-light, contrast is enhanced from a shadow cast by a raised portion of a label or created in a recessed, engraved portion of the label. In engraved labels, for example, contrast between different heights in the label may be enhanced from shadows created in the recessed, engraved surfaces of the label. FIG. 7 shows an example of a sidelighting system where a height (711) of a structure in the label may be determined by the relationship between a width of a raised portion of the label (710) a width of an engraved portion of the label (712) and a configuration of a light source (701) and a detector (702). In this example, the light source (701) illuminates the label from the side, at an angle α measured relative to the topmost surface of the structure, while the detector (702) images the label from the opposite side, an angle θ measured relative to the topmost surface of the structure. The detector may be a camera or a bar code reader or other suitable detector of signals emitted by or reflected on the label.

The height (711) for the structure in the label may be determined after measuring the angle α at which the light source (701) casts a shadow (703) that is sufficiently long enough to be detected by the detector (702) as a shadow. Where the width of the engraved portion (712) is longer, the height (711) of the structure must be larger, otherwise the detector (702) at angle θ may not detect a shadow. In some embodiments, one or both angles α and θ may be adjusted in order to change the length of the shadow (703).

In certain aspects, the control computer (434) in the calibration system is configured to determine a height (711) of the label in view of angles α and θ, the width of a raised surface (710), and the width (712) of the recessed area that will be viewed. For example, the control computer (434) may determine a ratio of height to width for a single pixel in a 3D identification label. Referring to FIG. 7, a single pixel may have a height (711) and a width (710). An exemplary pixel may correspond to a distance of 1 mm or 1.1 mm. In some embodiments, the control computer may compute a pixel height to pixel width ratio for a 3D identification label. For example, a minimum pixel height to pixel width ratio (711:710) may be around 2.5 for a 15° lighting angle, 20° read-out angle. As thin or high pixels may break during post-processing, a maximum ratio pixel height to pixel width ratio may be 4 or 5, or may be higher. In some embodiments, the quantity of recessed width (such as 712) across the entire 3D identification label may be important for determining how much of a raised height (711) can be viewed as a shadow in a recessed width (712 or other recessed width). For example, the amount of available width may not be exceeded by raised structures that will be viewed as shadows in the recessed width.

In certain aspects, the height and width of the 3D identification label may be determined using a formula:

$$\frac{h}{w} = \frac{x w}{\frac{1}{tan α} + \frac{1}{tan θ}}$$

Where symbols are:
h: pixel height (711)
w: pixel width (710)
α: angle of light source
θ: angle of detector
x: number of pixels in the recessed width (712) which are shaded when structures in the 3D identification label have cast a shadow.

Using the formula, the pixel height to pixel width may be calculated so that the shadow (703) is long enough to cover the part of the recessed width (712) that is visible to the detector.

The pixel height to pixel width ratio may range from 1-10. Such a range may be suitable for a light source and a detector positioned at the same angle as one another, wherein the angle ranges from 7° to 55°. Angles outside of this range may be challenging to configure.

When 3D identification labels are designed according to the angles at which the light source and detector are positioned, there may be sufficient contrast due to the shadows generated. Accordingly, 3D identification labels designed in this manner may be manufactured using any process for additive manufacturing. If AAF processes are used, contrast may be enhanced by printing the 3D identification label at an angle relative to the build plate, and this contrast may be used to read the label.

In certain embodiments, engraved labels may be added anywhere on a part, as the contrast from these labels does not require a thin or translucent reference surface.

In some aspects, manufacturing an AAF label comprises selecting a spot on a part for an AAF label, generating a label planning area for placement of the AAF label, generating instructions for at least one of orientation, ratio of pixel height and pixel height, and size of the AAF label, sending instructions for the label to an AAF printer, and manufacturing the AAF label on the AAF printer according the instructions. The label planning area may be on the part itself, or may be on a tag that is attached to the part.

In some embodiments, the AAF label may be manufactured in a direction wherein all surfaces face downwards in the AAF printer.

The preceding specification has described with reference to specific embodiments thereof. Various modifications and changes may be made thereto without departing from the broader spirit and scope of the invention. The specifications and drawings are, accordingly, to be regarded in an illustrative sense rather than a restrictive sense.

What is claimed is:

1. A method for manufacturing a 3D identification label on an agent-assisted fusion (AAF) device, the method comprising:
receiving a digital representation of the 3D identification label;
generating instructions for manufacturing the 3D identification label, wherein the instructions when executed by the AAF device, cause the AAF device to orient the digital representation of the 3D identification label at an angle between 1° and 90° relative to a surface of a build plate of the AAF device; and
manufacturing the 3D identification label on the AAF device according to the instructions.

2. The method of claim 1, wherein the AAF device is a multi-jet fusion device.

3. The method of claim 1, wherein the 3D identification label is located on an object.

4. The method of claim 3, wherein at least one portion of the object is oriented at an angle parallel to the surface of the build plate.

5. The method of claim 1, wherein the 3D identification label comprises:
a reference surface including a first side and a second side located on opposite sides of the reference surface, and
a first raised surface formed above the reference surface on the first side.

6. The method of claim 5, wherein the 3D identification label further comprises a second raised surface formed above the reference surface on the second side.

7. The method of claim 5, wherein a distance from the first side of the reference surface to the second side of the reference surface ranges from 0.3 mm-0.5 mm.

8. The method of claim 1, wherein the 3D identification label comprises a reference surface and an engraved surface that is recessed into the reference surface.

9. The method of claim 1, wherein the 3D identification label comprises one or more geometric shapes.

10. The method of claim 1, wherein the angle is in a range between 15° and 45°.

11. The method of claim 1, wherein the build plate is parallel to a powder surface of powder in the AAF device.

12. The method of claim 1, wherein manufacturing the 3D identification label comprises manufacturing the 3D identification label on the AAF device using an agent.

13. The method of claim 12, wherein the agent is a binding agent.

14. The method of claim 1, wherein the 3D identification label is located on an object, and wherein generating the instructions comprises:
determining an orientation of the object relative to the surface of the build plate;
determining a first orientation of the 3D identification label with respect to the orientation of the object such that a second orientation of the 3D identification label with respect to the surface of the build plate is at the angle between 1° and 90°; and
positioning the 3D identification label on the object based on the first orientation.

15. A method for manufacturing a 3D identification label configured for reading under a light source, comprising:
determining an angle α for the light source and an angle θ for a detector used to read the 3D identification label, wherein α and θ are measured relative to a reference surface on the 3D identification label;
calculating a pixel height to pixel width ratio for at least one geometric structure in the 3D identification label based on the angles α and θ; and
manufacturing the 3D identification label, wherein the at least one geometric structure is designed to conform to the determined pixel height to pixel width ratio.

16. The method of claim 15, wherein the pixel height to pixel width ratio is in a range of 1-10.

17. The method of claim 15, wherein the pixel height to pixel width ratio is 4 or 5.

18. The method of claim 15, wherein α and θ range from 7° to 55°.

19. The method of claim 15, wherein the light source illuminates the 3D identification label from a side.
